(19) United States
(12) Patent Application Publication
(10) Pub. No.: US 2008/0280102 A1
(43) Pub. Date: Nov. 13, 2008

(54) Shear and water resistant felt pad

(76) Inventors: Marcel Brouard, Levis (CA); Raymond Perron, Levis (CA)

Correspondence Address: Marcel Brouard;C/o Paul Biron, P.O. Box 0732, Jackman, ME, 04945, US

(21) Appl. No.: 12/150,648

(22) Filed: Apr. 29, 2008

Related U.S. Application Data
(63) Continuation-in-part of application No. 10/652,651, filed on Sep. 2, 2003.

(51) Int. Cl. B32B 5/00

(52) U.S. Cl. 428/141

(57) ABSTRACT

A protector pad for use with a piece of furniture with legs, and having a flat body with a lower pad face to slide against surfaces and an upper pad face to be fixed to the leg. The flat body includes a base and a sole. The base includes a fabric with a superior face forming the upper pad face and an inferior face having first means for assembly. The sole includes a lower layer whose inferior face defines the lower pad face, and an upper layer with a superior face having second means for assembly to assemble the sole to the base along an interface plane. The first means includes a plurality of grabbing member hooks each providing an equal shear resistance in all directions parallel to the interface plane. Typically, a reinforced material in a central layer includes a felt impregnated by a hardened latex material.

The present invention is a Continuation in part of a prior application U.S. Ser. No. 10/652,651 filed on Sep. 2, 2003, now abandoned.

### BACKGROUND OF THE INVENTION

### PRIOR ART

The present invention refers to a preceding invention of the same author U.S. Pat. No. 10/652,651.

A search in the prior art revealed some systems that caught our attention:

HANES U.S. Pat. No. 6,866,913 issued on Mar. 15, 2005 recognizes including a piece of hook material, an adhesive strip attached to the hook material for attaching to the lower end of a furniture leg, and a piece of felt pad having a plurality of loop members for removably engaging the hook material.

SHEPARD U.S. Pat. No. 6,329,016 issued on Dec. 11, 2001 discloses needle-punching operations applying a foamed acrylic binder in the fabrication of loop products.

MANOR U.S. Pat. No. 5,807,161 issued on Sep. 15, 1998 describes a sanding application where mushroom type is being used and considered as performant as a J type hook material.

### SUMMARY OF THE INVENTION

Our findings have been to the effect that for sliding a felt pad over a floor especially if there is an appreciable weight thereupon, the structure of the hook members of the felt pad must provide generally equal resistance in shear in all directions, which is the case when the hooks are of a mushroom type, typically having a hard core latex. The mushroom type further allows the use of shallow hooks evenly distributed and not exceeding about 1.45 mm in height.

According to an aspect of the present invention, there is provided a protector pad for use with a piece of furniture with legs, the pad comprising a generally flat body with two opposite pad faces:
a lower pad face which is soft, destined to slide against delicate surfaces without scratching them and,
an upper pad face destined to be fixed to the bottom of said leg of the piece of furniture, the flat body being constituted of two pieces, a base and a sole; the base comprising a fabric with a superior face forming the upper pad face and an inferior face comprising first means for assembly; the sole comprising a lower layer whose inferior face defines the lower pad face, and an upper layer with a superior face comprising second means for assembly to assemble the sole to the base along an interface plane, wherein the first means for assembly comprise a plurality of grabbing member hooks, each member hook providing a substantially equal shear resistance in all directions generally parallel to the interface plane.

Typically, a central layer of said sole, located between said lower and upper layers, comprises a reinforced material, preferably comprising a felt impregnated by a hardened material coming from a group comprising a latex base.

### BRIEF DESCRIPTION OF THE DRAWINGS

FIG. 1A shows a perspective view of the pad seen from the top;

FIG. 1B shows a perspective of the pad of FIG. 1A seen from the bottom;

FIG. 2A shows an alternative to the pad of FIG. 1B seen from the bottom;

FIG. 2B shows a detailed view of the pad of FIG. 2A seen from the top;

FIG. 2C shows an enlarged view of the pad of FIG. 2B once assembled;

FIG. 3A shows a front view of the prior art; and

FIG. 3B shows a front view of the pad of FIG. 2A.

### DETAILED DESCRIPTION OF THE PREFERRED EMBODIMENTS

In the following description and in the accompanying drawings, the numeral numbers refer to identical parts in the various Figures.

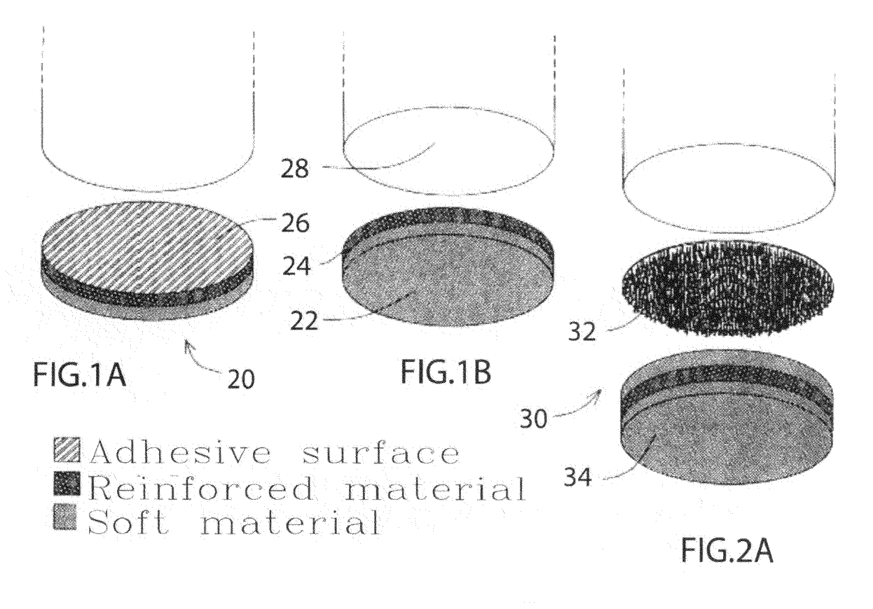

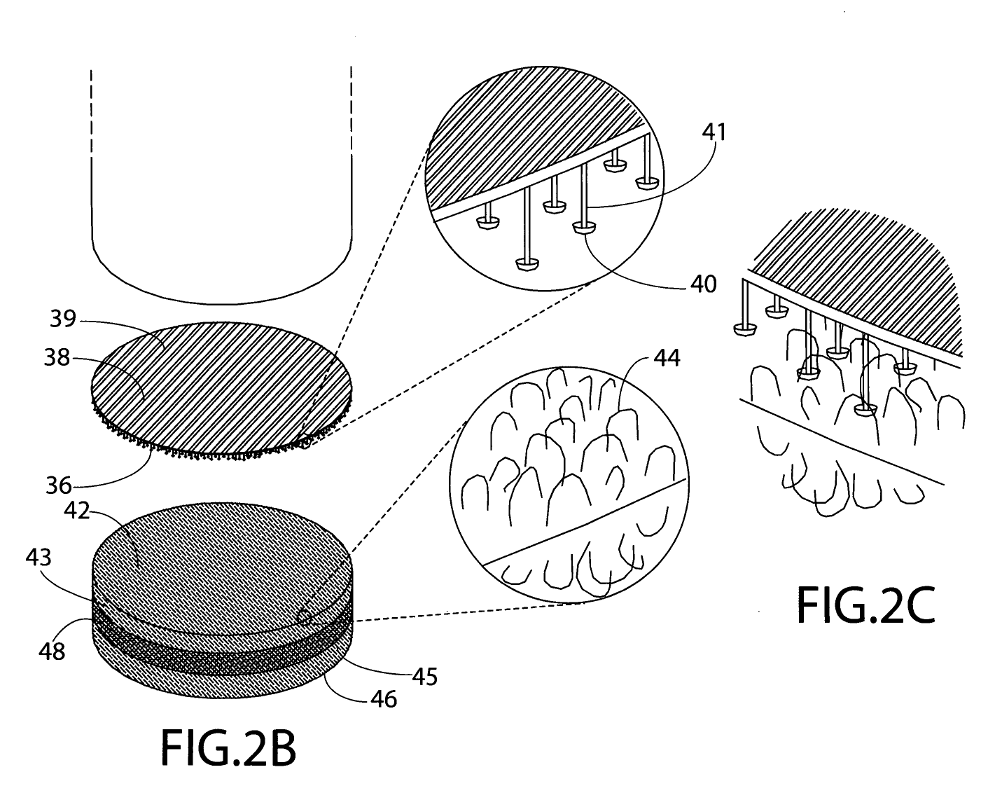

FIG. 1 and FIG. 2 both show a pad having an adhesive incorporated side and another side which is soft and can slide on a surface without damaging it.

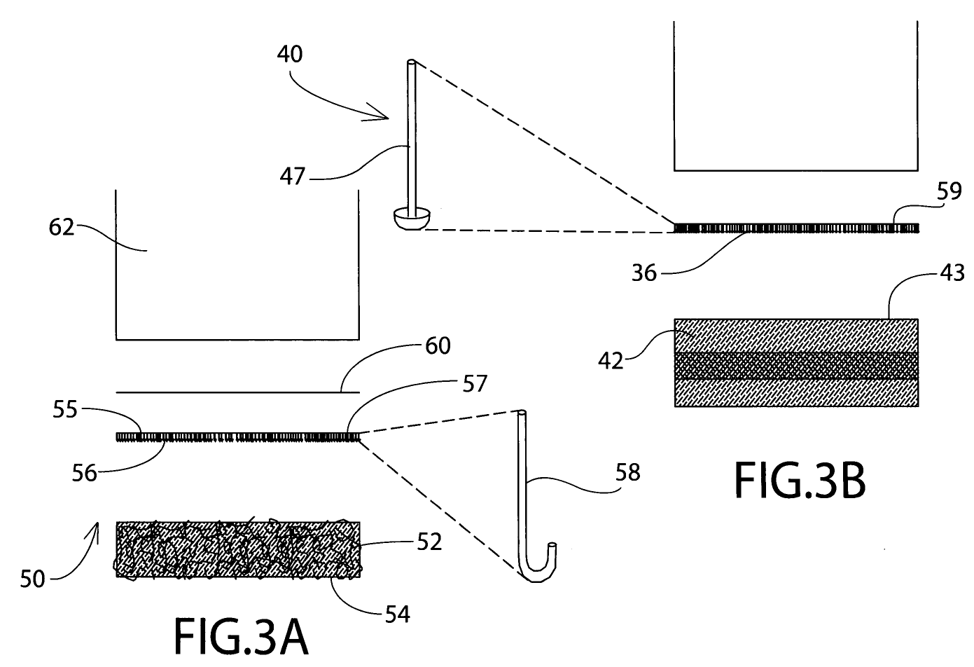

FIG. 3A and FIG. 3B illustrate the differences between the present innovation and the prior art.

FIG. 1A shows a permanent protector pad 20 which may be built with an inferior surface 22 made of soft material, and a reinforced upper section 24, preferably reinforced by the infusion of a resin in the fibrous material of the pad. The upper section comprises an adhesive upper surface 26, wherein the adhesive is preferably incorporated by injection in the upper surface of the superior section of the pad, in the reinforced material, in a way to provide an even upper adhesive surface. In FIG. 1A the pad is shown viewed slightly from the top whereas in FIG. 1B the pad is shown viewed slightly from the bottom.

FIG. 1B also shows the general shape of the bottom of the leg 28 of a piece of furniture underneath which may be installed the pad.

FIG. 2A shows a perspective view of a replaceable protector pad 30 shown slightly from the bottom and composed of two pieces: a fixed base 32 and a replaceable sole 34.

FIG. 2B shows a perspective viewed slightly from the top where one can see two enlarged windows showing the material of the sole and the material of the base. In the main view, one can see that the base is made of a fabric 38 underneath which is a grabbing material 36 and on top of which is incorporated an adhesive substance in a way to provide an even upper adhesive surface 39. The grabbing material consists of a mushroom 40 like Velcro™ type material consisting of many mushroom-like grabbing members. Each member has a typical height of mushroom 41 less than about 1.45 mm. Preferably heights will be from about 1.00 mm to about 1.45 mm.

The sole 34 is made of three sections: a superior section 42 made of a material comprising fibers 44 forming arches which will be restrained by the mushroom-like members in a way that the sole may be fixed upon the base. The sole also comprises a bottom section 46 made of a soft material that may slide without damaging floor surfaces. The sole also comprises a middle section 48 which is made of a firm material. This way the complete sole is much more resistant to shear stress constraints. Typically, in the bottom and top sections felt may be used as material. It is also possible to build the sole material by joining two sheets of felt using a heat process at the surfaces which are in contact. In this way, the center material melts and then hardens, constituting the firmer center section material. In production both sheets of felt are unrolled and gradually approached to each other. At the moment of junction, a flame causes the fibers at the surface of the contact surfaces to melt and join, and then harden. This type of felt has a better shear resistance than the original material, and gives a stronger resistance to the entire assembly. This is very important for a long lasting protector pad.

FIG. 2C shows an enlarged view of the side of the sole fixed to the base. The mushroom-like grabbing members restrain the fibers of the soft upper section from being removed, especially during shear stress. The sole fixed in this way is particularly resistant to shear constraints, however, a relatively light constraint in a parting and a lifting permits the removal of the sole for replacement after normal wear.

FIG. 3A shows the pad of the prior art 50 which is made of three parts: a fibrous pad 52 reinforced with stronger fibers 54, a hook material with a grabbing inferior section 56 comprising hooks members 58, an irregular uneven superior fabric surface 57 and a double sided adhesive tape 60.

We found the problem with this construction is that the adhesive tape is only in contact with a fraction of the upper surface because this surface is irregular. Since it is embossed, only the elevated fraction of the surface keeps contact with the tape. Furthermore, since the upper surface of the protector pad is porous, water, soap and humidity may infiltrate and attack the adhesive tape when the pad is exposed to such elements in events such as mopping of the floors. The adhesive tape is very weak against water and has a tendency to lose its adhesion either to the pad or to the underneath of the furniture legs as soon as it is moistened. This may lead to the loss of the protective pad and to floor damage when the loss goes unnoticed. This is why a strong, durable and water-resistant adhesion is not only important to protect floors, but critical.

The felt may break down in layers or by pieces. In order to reinforce the felt sole in the prior art model, stronger fibers 54 are added to the typical felt material 52. These stronger reinforcing fibers are firmer than felt and therefore may damage the floor surface noticeably if it is slided repeatedly. It will not damage the surface as the furniture legs might however produce a long term scratching effect. This is why we found it is imperative to provide a lower surface made entirely of soft material.

FIG. 3B shows an application of the present invention: the fact of reinforcing the sole only at its center 48 leaves pure material to slide on the surfaces without damage while keeping an increased overall shear strength. This also permits the upper surface material 42 to be grabbed by the mushroom-shaped grabbing material 36 of a sticky strip 59. A grabbing mushroom 40 has a short height 47 (about 1.00 mm to 1.45 mm) permitting to cling to an upper felt sheet 43. The density of such grabbing mushrooms is typically 110 units per cm². The incorporation of the adhesive is achieved in the fabric of the base, it makes the superior surface even so the entire surface is exposed to adhesion to the furniture leg. This also reduces the quantity of pores in the material, and therefore limits the infiltration of water. Furthermore, the use of mushroom-shaped grabbing members instead of the J-shaped ones gives a great increase in shear effort resistance. Overall, this protector pad is much stronger against shear efforts and against humidity and water.

### TYPICAL TECHNICAL SPECIFICATIONS

Weight density: 370 g/m²

Unit density: 110 heads/cm²

Peel strength: 5 N/cm²

Shear strength: 60 N/cm²

Breaking strength: 350 N/cm

A protector pad for use with a piece of furniture with legs, the pad comprising a generally flat body 30 with two opposite pad faces:
a lower pad face 22 which is soft, destined to slide against delicate surfaces without scratching them and,
an upper pad face 26 destined to be fixed to the bottom of said leg 28 of the piece of furniture, the flat body 30 being constituted of two pieces, a base 32 and a sole 34; the base comprising a fabric 38 with a superior face forming the upper pad face and an inferior face 36 comprising first means for assembly; the sole comprising a lower layer 46 whose inferior face defines the lower pad face 22, a central layer 48 comprising a reinforced material and an upper layer 42 with a superior face 43 comprising second means for assembly to assemble the sole 34 to the base 32 along an interface plane, wherein the first means for assembly comprise a plurality of grabbing member hooks 36, each member hook providing a substantially equal shear resistance in all directions generally parallel to the interface plane, the reinforced material in the central layer comprising a felt impregnated by a hardened material coming from a group comprising a latex base.

The member hooks 36 defines mushroom type hooks comprising a unit density of a number of about 110 heads/cm² of a height not exceeding about 1.45 mm. The mushroom shapes offer a form of hook which is equally strong all around, on 360°, in shear resistance. They tend to grab more than one fiber at a time. Hence, they are resistant to shear effort applied in any direction and stay easy to change when an effort is applied in tension (peel).

The shear resistance has a strength of about 60 N/cm².

The weight density of the member hooks 36 is at least about 350 g/m² and having a breaking strength of about 350 N/cm.

The second means of assembly 42 comprise fibers forming arches 44, the upper layer 42 of the sole 34 comprises a felt the fibers thereof forming the arches, the felt comprises materials from a group comprising polyester and natural fibers, the superior layer 42 and inferior 46 layers are made of felt material, the felt material consists either of polyester or natural fibers.

The said reinforced material is hardened felt comprising injected latex.

The grabbing member hooks 36 providing a high shear resistance are of a mushroom shape of a height shorter than a corresponding height of a J-shape hook 58, such that the hooks of the present invention are stiffer, in the shear direction, than the conventional J-shape hooks.

In the present invention there are no melt fibers added thereby maintaining softness of felt pad (felt pads for such application have been sold in the U.S. since 1991). Moreover, the mushroom hooks provide a much stronger gripping power (360°) than the Hanes' protection system: comparing to the Hanes′ system equipped with loop hooks, my system outfitted with mushroom hooks grip on automatically over a multitude of felt fibers and consequently, render my invention more efficient. I have shown a shear test figure (FIG. 1). To test fibers subjected to either loop hooks or mushroom loop hooks and by sliding one pad over the other, it can be readily demonstrated, a person may separate hooks and loops system with a normal, for instance, twenty pound strength. The said person may not be able to separate mushroom and loop system because the latter (mushroom) has a greater surface area of contact over 360° as shown on FIG. 1.

This invention is particularly efficient because of a need of keeping softness of felt in contact with floor and to provide extra shear strength.

It is to be clearly understood that the instant description with reference to the annexed drawing is made in an indicative manner and that the preferred embodiments described herein are meant in no way to limit further embodiments realizable within the scope of the invention. The matter which is claimed as being inventive and new is limited only by the following claims.

### PARTS

20 Permanent protector pad
22 Soft inferior surface
24 Reinforced upper layer
26 Adhesive superior surface
28 Furniture leg
30 Replaceable protector pad
32 Fixed base
34 Replaceable sole
36 Grabbing material
38 Upper material with adhesive
39 Uniform adhesive surface
40 Grabbing mushrooms
42 Upper layer
43 Upper felt sheet
44 Fibers forming arches
46 Lower layer
47 Short height
48 Central layer
50 Prior art
52 Felt
54 Strong fibers
55 Grabbing fabric
56 Grabbing surface
57 Uneven upper face
58 Hooks
59 Sticky strip
60 Double sided adhesive tape
62 Furniture leg

We claim:

1. A protector pad for use with a piece of furniture with legs, said pad comprising a generally flat body (30) with two opposite pad faces:
a lower pad face (22) which is soft, destined to slide against delicate surfaces without scratching them and,
an upper pad face (26) destined to be fixed to the bottom of said leg (28) of said piece of furniture, said flat body (30) being constituted of two pieces, a base (32) and a sole (34); said base comprising a fabric (38) with a superior face forming said upper pad face and an inferior face (36) comprising first means for assembly; said sole comprising a lower layer (46) whose inferior face defines said lower pad face (22), and an upper layer (42) with a superior face (43) comprising second means for assembly to assemble said sole (34) to said base (32) along an interface plane, wherein said first means for assembly comprise a plurality of grabbing member hooks (36), each member hook providing a substantially equal shear resistance in all directions generally parallel to said interface plane.

2. The protector pad of claim 1 wherein a central layer (48) of said sole, located between said lower (46) and upper (42) layers, comprises a reinforced material.

3. The protector pad of claim 2 wherein said reinforced material in said central layer comprises a felt impregnated by a hardened material coming from a group comprising a latex base.

4. The protector pad of claim 1 wherein said member hooks (36) includes mushroom type hooks.

5. The protector pad of claim 4 wherein said mushroom type hooks have a unit density of a number of about 110 heads/cm² and a height not exceeding about 1.45 mm.

6. The protector pad of claim 1 wherein said shear resistance has a shear strength of about 60 N/cm².

7. The protector pad of claim 4 wherein said member hooks (36) have a weight density of at least about 350 g/m² and have a breaking strength of about 350 N/cm.

8. The protector pad of claim 1 wherein said second means of assembly (42) comprise fibers forming arches (44), said upper layer (42) of said sole (34) comprises a felt the fibers thereof forming said arches, said felt comprises materials from a group comprising polyester and natural fibers, said superior layer (42) and inferior (46) layers are made of felt material, said felt material consists either of polyester or natural fibers.

9. The protector pad of claim 2 wherein said reinforced material is hardened felt comprising injected latex.
